(19) United States
(12) Patent Application Publication
(10) Pub. No.: US 2004/0011121 A1
(43) Pub. Date: Jan. 22, 2004

(54) System and method for abating a gas flow containing volatile organic compounds

(76) Inventors: Michael Joseph Ashe, Berkshire (GB); Christopher Steven Buchanan, Hampshire (GB)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/312,163

(22) PCT Filed: Jun. 13, 2001
(86) PCT No.: PCT/GB01/02608

(30) Foreign Application Priority Data
Jun. 22, 2000 (GB) 0015171.2
Oct. 3, 2000 (GB) 0024153.9
Mar. 13, 2001 (GB) 0106065.6

(51) Int. Cl. G01M 19/00

(52) U.S. Cl. 73/118.1

(57) ABSTRACT

A system and method for the abatement of industrial process gases utilizing a combustion engine in combination with an oxidizer. The use of these two elements in conjunction with the use of concentrating equipment where required provides for an energy efficient pollution control method. Means are provided for splitting the gas flow into two streams in any proportion or manner, the first stream mixed with air being passed to a combustion engine, the second being passed to the combustion unit. Means for detecting and controlling are also provided to provide optimal ratio/quantity of gases to the engine in accordance with its requirements.

### BACKGROUND TO THE INVENTION

The present invention relates generally to the abatement of atmospheric pollution and more particularly to a system for abating a gas flow containing volatile organic compounds (VOCs).

This invention encompasses conventional oxidation techniques, the principles of combined heat and power and internal combustion engine technology. To set this present invention in context these areas of prior art are briefly reviewed below.

### DESCRIPTION OF THE RELATED ART

Conventional Oxidation Techniques.

The phrase ‘volatile organic compounds’ (VOCs) will be used here to refer to carbon containing Compounds which might cause an atmospheric pollution problem. In the majority of cases VOCs are encountered as dilute concentrations in large air volumes. The term ‘VOC flow’ will be used hereon to refer to VOCs in any carrier gas. Typical concentrations are in the range 1-10 g/NM³ in typical flows of 5,000-100,000 Nm³/hour, but concentrations and flows can be encountered outside of these ranges. VOC flows can vary in composition, concentration and in volume from day to day, even from the same process. The term ‘industrial process’ will be used here to describe the wider industrial activity that produces the VOC flow.

Thermal and catalytic oxidisers are generally used to oxidise VOCs to water and carbon dioxide. For thermal oxidisers the ignition temperature generally ranges from 760 C. to 980 C., and for catalytic oxidisers the range is typically 200 to 400 C. These reaction temperatures are substantially greater than the temperature of most VOC laden air streams leaving an industrial process. Consequently VOC flows are often preheated via a heat exchanger using hot exhaust gases from the downstream combustion process. When necessary oxidisers burn support fuel in order to Increase the temperature of the VOC flow to the required level. In all the oxidiser designs the objective is to use the calorific value of the VOCs to minimise the amount of support fuel required. When the VOC concentration reaches a certain minimum level there is no need for support fuel, and the system can be said to be autothermic. Developments in oxidiser design have been directed to increasing the thermal efficiency of the system and hence reducing support fuel costs, for example U.S. Pat. No. 5,967,771. When the VOC concentration is sufficiently high, surplus heat may be available for process heating within the wider industrial process, however the net effect of purchasing an oxidiser is an ongoing financial burden for the user.

Regenerative heat exchangers are used in both thermal and catalytic oxidisers; they have a thermal efficiency of typically 70 to 95%. A regenerative thermal oxidiser exhaust is typically 55 C. and a regenerative catalytic oxidiser typically 30 C. Most regenerative systems incorporate flow reversal design, combined with heat sink packing material in two or more fixed beds to achieve an optimum thermal efficiency. An example of such is disclosed in patent U.S. Pat. No. 3,895,918. The high thermal mass of the packing material in regenerative systems means that whilst it is energy efficient during operation, there is a large fuel requirement on start up. This may be an issue for industrial processes where there is intermittent VOC production. There is also a high electrical parasitic load associated with regenerative schemes due to the pressure drop across the packing material.

Recuperative heat exchangers such as shell and tube designs are most commonly used in both thermal and catalytic oxidisers. They are relatively inexpensive to construct and have low electrical parasitic requirements. Recuperative exchangers have a maximum thermal efficiency of about 70% and this means that for dilute VOC flows more support fuel will be needed than for a regenerative systems.

Regenerative heat exchangers only become cost effective for VOC flow rates of approximately 50,000 Nm³/hour or more, whilst due to their lower capital costs recuperative heat exchangers are used at flow rates below 50,000 Nm³/hour.

Given the onerous pollution control duty, oxidisers are designed to be very reliable with downtime of less than 1%.

Concentration Techniques

When VOC flows are characterised as being very large with small concentrations of VOCs it is often desirable to concentrate the VOCs into a smaller flow and so reduce the cost of any associated oxidiser plant. This can be achieved by either recycling the VOC back to the process or employing an absorption/desorption process such as that described in patent W09530470. The degree of concentration that can be achieved by these techniques is limited to the maximum concentration permitted in the industrial process. These limits are set by safety considerations usually at around 25% of the lower explosive limit (LEL) of the solvent/air mixture to avoid the risk of explosions. The downstream oxidiser is then sized to accommodate the relatively small desorbed flow from the concentrator. VOCs are removed from concentrator devices by a relatively small high temperature flow of a nitrogen, steam or air. The resultant desorbed flow will therefore be at an elevated temperature compared with the exhaust VOC leaving the industrial process. Furthermore, if the concentrator is of a batch design the temperature of the desorbed flow will vary throughout the batch cycle.

Engine Oxidation Techniques

Engine oxidisers destroy waste in a combustion engine that drives an electrical generator. This produces electricity and hot exhaust gases from the engine. A support fuel may be used where required. Producing electricity in this way can be commercially attractive depending on the energy value of the waste.

The prior art has been to aspirate the VOC laden air into the engine in place of the combustion air, and make up the difference in fuel through the normal engine fuel system, heron referred to as ‘support fuel”, see for example patent EP0,566,304 (reciprocating engines) and U.S. Pat. No. 5,673,553 (gas turbines). Gas turbines have the advantage of being able to aspirate up to three times greater air volumes per kW of electricity produced than reciprocating engines. However, reciprocating engines are almost twice as efficient as turbines at converting the calorific value of fuel into electricity in the key industrial power demand range of 0.5 to 1 MW.

There is a conflict between the constant air volume requirements of combustion engines and the variable nature of VOC flows. For this reason concentration equipment using an absorption/desorption process are suggested ( Cooper & Little, WO9530470) to modulate the VOC flow from an industrial process prior to an engine oxidiser.

A drawback of the prior art is the requirement to size the combustion engine to accommodate the VOC flow. Further drawbacks include the need for engine alterations, which in the case of the gas turbine means a new combustion chamber design. In the case of reciprocating engines, the addition of VOC molecules to the support fuel will reduce the resistance to knocking in the engine. This may require alterations to the ignition timing point, or possible de-rating of the engine.

Notwithstanding engine alterations, there are limits to the VOC concentration that can be passed to combustion engines. In the case of gas turbines this will be connected to flame stability within the combustion-chamber. As will be known to one skilled in the art of gas turbine technology, it is necessary to have a stable ‘flame front’ in part of the combustion chamber known as the ‘flame tube’. This can only be achieved by adding support fuel to create the appropriate air to fuel ratio at this point. For a particular size of gas turbine, the energy contribution from the VOCs puts an upper limit on the amount of support fuel that can be added and if this brings the air to fuel ratio below the required level then there is a risk of flame failure. In the case of reciprocating engines there are limits in the methane number beyond which it will not be possible to operate the prior art.

A further drawback to the prior art engine oxidisers is that engines are subject to breakdown, and require maintenance. The fraction of time per year that the engine is functioning correctly after allowing for routine maintenance and unexpected repairs is commonly referred to as ‘availability’. The availability for most commercial engines in the sub-10 MW range is between 90 to 93%. So for between 7 to 10% of the time the engine is not working and therefore there is no pollution control.

### SUMMARY OF THE INVENTION

The present invention is directed to apparatus and methods for treating VOC flows and more particularly to a system that links the use of VOC abatement equipment with combustion engines to provide a process that addresses the shortcomings of both prior arts.

According to the present invention there is provided a system for abating a gas flow containing volatile organic carbons (VOCs) consisting of one or more streams comprising:

a) At least one combustion engine, primary fuel flow, for the purpose of generating power;

b) An air stream into the combustion engine;

c) A combustion unit for oxidising VOC;

d) Means of splitting the gas flow into at least two streams A and B, in any proportion or manner, so that stream A passes to the air stream of one or more of the combustion engines in any proportion, forming a combined stream C and stream B passes to the combustion unit;

e) Means for detecting the VOC concentration and/or flow rate of stream A and/or the combined stream C of the air stream and stream A and means for controlling the air stream and/or stream A and/or stream C and/or means for controlling the primary fuel to the engine(s) in response to the detected VOC concentration and/or flow rate to provide the optimal ratio/quantity of gases to the engine in accordance with the requirements of the engine;

The system may additionally comprise a means for transferring at least a portion of the exhaust heat from the engine Into stream B.

According to a second aspect of the present invention there is provided a method of oxidising a gas flow of one or more streams containing volatile organic carbons comprising the steps of:

a) Splitting the gas flow into two streams A and B in any manner or proportion;

b) Mixing stream A in any proportion into the air stream of one or more devices for generating power, forming a combined stream C, where the device for generating power has a primary fuel flow;

c) Detecting the mass flow and/or concentration of VOCs in stream A and/or the combined stream C of the air stream and stream A;

d) Controlling the air stream and/or stream A and/or stream C and/or the primary fuel flow to the devices for generating power in response to the detected VOC concentration and/or mass flow rate to provide the optimal ratio/quantity of gases in accordance with the requirements of the devices for generating power;

e) Passing stream B into any VOC control device.

Additionally the method may comprise the step of heating stream B with at least a portion of the exhaust heat from the devices for generating power.

In this approach it will be seen that combustion engines can be used to oxidise VOCs for the purpose of electrical generation or other mechanical duties, whilst achieving the same level of reliability as conventional oxidisers.

The present invention splits the VOC flow into two streams, one flow is directed to the air intake of one or more combustion engines. Most of the VOCs associated with this stream will be destroyed, along with support fuel, as part of the normal combustion process within the engine, in so doing the temperature of this stream will rise to typically 500 C. The quantity and concentration of the VOC laden air that passes through the engine is controlled, as will be described, so that substantially normal operation of the engine can occur within the engine manufacturers' specification. In this way it is possible to use off-the-shelf engines.

The second stream passes to any standard VOC abatement device, such as a solvent recovery plant, biological treatment etc., but is preferably an oxidiser of the thermal or catalytic art where the combustion process can be supported by waste heat from the engine exhaust if required.

It will be apparent then that a fundamental difference between this approach and that of the prior art ‘engine oxidisers’ is that in this case a proportion of the VOC is not being used to generate power in an engine. The previous methods were directed at extracting all the energy content of the VOCs within an engine. The approach of this patent application is therefore less efficient at utilizing VOCs for the purpose of power generation. This reduction in efficiency is brought about so that the energy needs and VOC destruction requirements of the industrial process are balanced. Thus the method and apparatus of the present invention, through reducing the efficiency of the VOC-to-power process, yields considerable benefits in terms of VOC destruction reliability, and optimum CHP sizing for the particular application.

### BRIEF DESCRIPTION OF THE DRAWINGS

Further advantages and details of the invention are described by way of example only in greater detail hereinafter with reference to these drawings:

FIG. 1 shows a block diagram of the apparatus and method of the present invention.

FIG. 2 shows a typical layout of the apparatus according to the present invention, in which an engine is used in conjunction with a catalytic oxidiser to provide a VOC destruction scheme.

### DESCRIPTION OF THE PREFERRED EMBODIMENTS

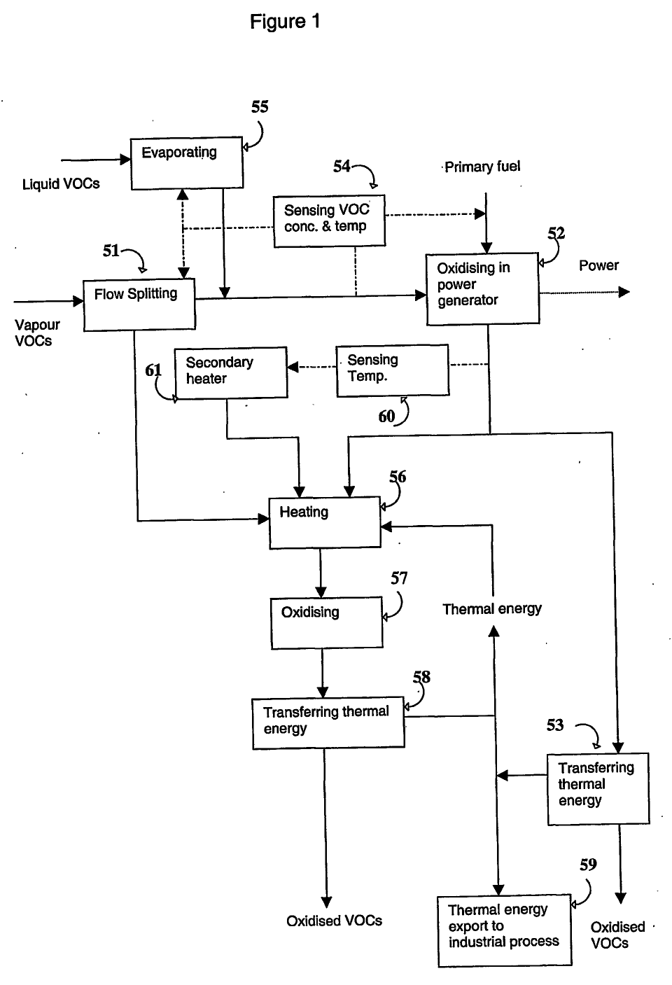

Firstly the Method and Apparatus of the Present Invention will be Illustrated in Block Diagram Form with Reference to FIG. 1:

Vapour phase VOCs are split in unit 51, a portion of the flow passing to engine 52, where the VOCs are oxidised, generating heat from the engine exhaust and electricity via generator 53. In this context the term ‘engine’ is understood to mean multiple units of any power-generating device where hydrocarbons are used as a fuel source such as reciprocating engines, gas turbines and fuel cells. An appropriate size of engine 52 is selected in order to generate the optimum economic power requirements for the wider industrial process. The ‘optimum economic power requirements’ will vary from site to site, and may involve the export of electrical power to the local grid, it may also mean that some of the engine exhaust heat is wasted. Parameters such as, VOC concentration, flow rate temperature, engine knock and primary fuel flow to the engine can be measured by sensor 54 and used to control the VOC splitting unit 51. Any change in the total VOC energy flow to the engine brought about by the action of splitter unit 51 will result in a change in the primary fuel flow to the engine so that a substantially constant energy flow is provided to the engine 52. Where necessary air may be added to reduce the VOC concentration and temperature of the VOC stream to engine 52, in accordance with the requirements of the engine. Liquid phase VOCs can be evaporated 55 into the VOC flow to the engine 52, the evaporation is similarly controlled via the concentration and temperature measurement 54 In accordance with the requirements of the engine

The balance of the VOC flow Is passed to heater 56 and then to oxidiser 57 where the VOCs are destroyed to the extent required by legislation. Heat exchanger 58 extracts energy from the exhaust of oxidiser 57 allowing the cooled oxidised process gases to be discharged to atmosphere. The sources of energy for heater 56 can be the engine exhaust 52 and/or exchanger 58. In the case where engine 52 exhaust is used for this purpose sensor 60 will detect when engine 52 is offline and compensate by initiating secondary heater 61. When the exhaust from engine 52 does not pass through the oxidiser unit 57 a final abatement stage such as an oxidiser, for example of the catalytic type, can be added to the engine exhaust if necessary to comply with local environmental legislation.

In the event that energy available from unit 58 is not required for heater 56, then this surplus shall be exported for wider use in the industrial process via exchanger 59, by-passing the oxidiser 57.

It will be recognised that any form of VOC abatement may be used, such as biological, solvent recovery, cryogenic or dispersion in place of the oxidiser.

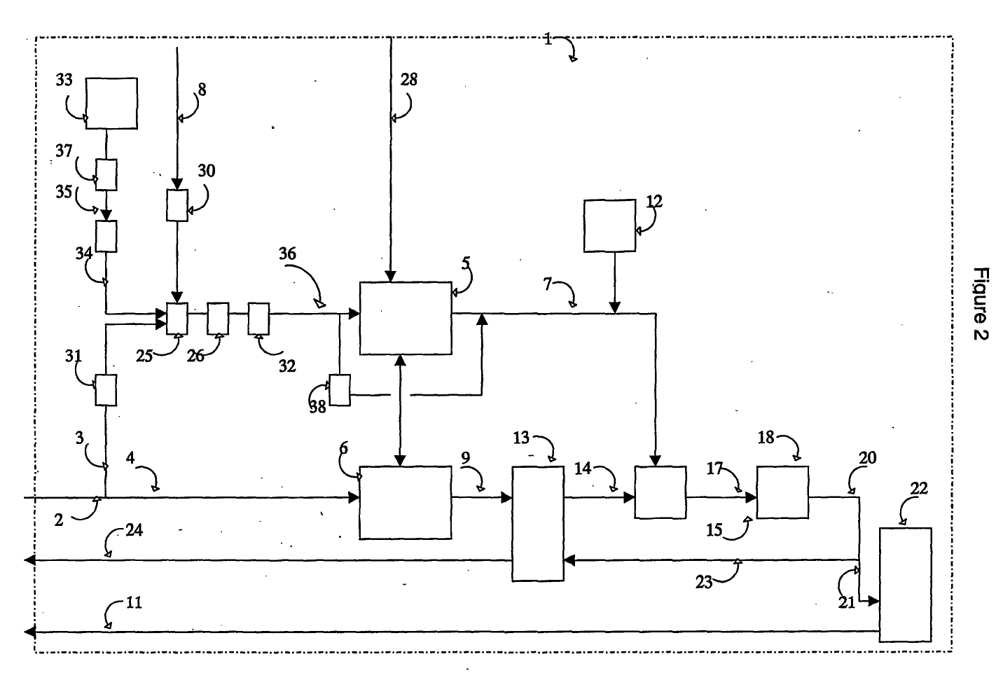

A more detailed, description of a preferred embodiment is now described with reference to FIG. 2, for the case when a catalytic oxidiser is used. It will be appreciated that the present invention will be equally relevant to using other types of oxidation technology where minor changes would be needed to the equipment layout.

A VOC abatement system is generally identified by 1. The system 1 receives air containing VOCs in flow 2 either directly from the process or via some form of concentrating equipment. Flow 2 is split into streams 3 and 4. In practice flow 2 may consist of multiple separate streams, and the manner in which streams 3 and 4 are formed will be to optimise the overall economic benefit of the installation. For example if all the streams making up flow 2 are identical other than by temperature, it is preferential to group together the cooler streams for passing to the air intake of the engine, i.e. stream 3. Similarly, if the streams have different compositions or concentrations it may be advantageous to pass the streams with the highest energy potential to the air inlet of the engine. Stream 8 provides a balance of fresh air so that the combined flow of streams 3 and 8, designated as stream 36, is the correct volumetric capacity required by engine 5.

Stream 36 is treated by the engine as though it were clean air for combustion within the engine, and mixed with support fuel 28 in the normal manner specific to each engine design. Combustion of the VOCs present in stream 36 occurs as part of the normal engine combustion process, and the associated energy release will reduce support fuel 28 running costs. Fuel flow 28 is controlled by the engine control system specific to each manufacturer.

Engines of the reciprocating art are generally cooled through a heat exchanger (i.e. a radiator) 6, in the case of a gas turbine it is cooled by internal air bypasses. In all cases an engine exhaust shall be produced as stream 7 which is typically around 500 C.

All engines have some tolerance to burning VOCs. The concentration of VOC that a particular engine can handle will depend on the nature of the engine and the type of VOCs. The flow of stream 3 shall be such that the selected engine can handle the associated VOCs to the satisfaction of the engine manufacturer without the need for engine modifications. In the case of reciprocating gas engines for example this means that the methane number of the mix to the engine will be within the recommendations of the engine manufacturer so avoiding undue knocking within the engine cylinders. This Invention will be of particular benefit to the prior art engine oxidisers when the VOC concentration in stream 2 is higher than the manufacturers' specification. In this case dilution stream 8 will reduce the concentration with the balance handled as described herein.

It will be appreciated that a control scheme to regulate the VOC flow to the engine 5 from stream 3 can be achieved in a number of ways for this purpose. Here, stream 3 containing VOCs is mixed with fresh air 8 in mixer 25. Analyser 26 measures the VOC content of stream 3 or of the subsequent mix with fresh air 8 prior to passing to combustion engine 5. Analyser 26 may be any suitable type for this purpose such as a total hydrocarbon measuring device, or a gas chromatograph. If the VOC level exceeds a certain predetermined concentration for this application specified by the engine manufacturer, then the ratio of stream 8 to 3 is adjusted via control valves 30 and 31. Under certain conditions stream 3 may be zero. Alternatively indirect detection of the VOCs can be used as a signal to the control system, e.g., through the engine diagnostic system. As an example reciprocating gas engines are very sensitive to changes in VOC concentration which can cause knocking within the engine cylinders. Therefore a convenient method of controlling VOC flow to the engine is to utilise the knock sensor associated with an engine in a feedback control scheme. In this case there is no need to predetermine the VOC capacity of the engine.

The effect of changes in the concentration of VOCs to an engine will have the effect of altering the temperature of the gaseous flow through an engine. It may therefore also be convenient to use certain key temperatures as a means of detecting VOC concentration changes and then triggering a control response. As an example in the case of gas turbines this could mean monitoring the gaseous flow after the combustion chamber and when the temperature moves outside a pre-arranged band taking action to adjust the primary fuel flow.

Some engine designs require a gradual change in fuel composition to operate properly. On start-up of the industrial process the VOC concentration may rise rapidly. Analyser 26 can be used in conjunction with control valves 30 and 31 as previously described to dampen concentration changes to the satisfaction of the engine manufacturer.

Most reciprocating engines perform best at temperatures below 40 C., whereas gas turbine performance will be adversely effected if the air temperature rises much above 20 C. Accordingly the control scheme described herein can be programmed to control the temperature of stream 36 with temperature measuring device 32 in conjunction with valves 30 and 31. It will be noted that this feature is of value when the VOC flow from the industrial process is hot, as might be the case on leaving a process drying oven, for example.

It may be desirable to allow the output of the engine to fluctuate with changes in air temperature, in, which case the primary fuel flow to the engine can be adjusted accordingly.

Industrial processes that produce VOCs quite often accumulate waste liquid-phase solvents. Accordingly it is part of the present invention that provision for the disposal of this waste is made. This can conveniently be achieved by feeding liquid from storage tank 33 into mixer 25 via vaporiser 35. Vaporiser 35 may be any convenient device for this purpose such as a heater or atomiser. In this way the concentration of VOCs to engine 5 can be augmented when the concentration of stream 3 falls. The flow of stream 34 is controlled to provide the correct quantity of VOC to engine 5, using analyser 26 to control valve 37, or by some alternative convenient control method, such as engine diagnostic measurements. It may be convenient to determine the flow of liquid-phase VOC to the system indirectly by measuring the change in temperature brought about by evaporating the liquid-phase VOC into airflow.

It will be noted that provision is made here for support fuel stream 28 to represent the total fuel requirement of the engine, hence the engine is capable of operation Independent of the VOC flow.

With continued reference to FIG. 2, stream 4 shall pass through heat exchanger 6, leaving at an elevated temperature as stream 9. In the event that engine 5 has no exchanger 6, or for economic reasons the heat from exchanger 6 can be used elsewhere in the industrial process, such as in an absorption chilling plant, then the streams 4 and 9 shall be identical.

Stream 7 will be at a temperature of about 500 C. and stream 9 will be at a lower temperature, depending on the function of exchanger 6 and the temperature of stream 4.

The low temperature stream 9 shall pass to heat exchanger 13 and leave at an elevated temperature as stream 14. Heat exchanger 13 can be any suitable type of heat exchanger such as a plate, shell and tube, or regenerative. It can be seen that heat exchanger 13 will be smaller than would be the case if a prior art catalytic oxidiser were used, when the heating duty would be for the whole of stream 2. This will reduce capital and running costs of this element.

Stream 14 is heated by the energy present in stream 7 in device 15. Device 15 is preferably a mixing chamber for the purpose of combining streams 14 and 7. If the energy transferred in device 15 is sufficiently large, then the need for heat exchanger 13 is removed.

If the exhaust from engine 5 in stream, 7 is within the permitted exhaust levels allowed for in the relevant local legislation then device 15 may alternatively be a heat exchanger. In this case stream 7 will exhaust to atmosphere after the exchanger.

The flow containing VOCs from device 15 shall be represented by stream 17. The temperature of stream 17 shall be at the required temperature to destroy the VOCs in a catalytic oxidiser 18. The sizing of the units and flowrates described herein is such that this temperature can be attained. This temperature will depend on the nature of the VOCs, the required destruction efficiency and the type of catalyst selected, but is typically in the range 200-400 C.

Exhaust heat from the engine is passed to catalyst bed 18 via mixer 15, and this means that there will be a stable heat source keeping the catalyst hot even when there is no VOC production. When the industrial process next generates VOCs the catalyst system will be available to oxidise the VOCs without delay. In the prior art catalytic system a warming-up period is required. Another advantage of this approach is that hydrocarbons associated with the engine exhaust will be destroyed by catalytic oxidiser 18, removing the need for a post-engine gas cleaning system.

Moreover the effect of the constant heat base load from engine 5 will allow greater turndown capacity for the catalytic oxidiser without the need for auxiliary firing, and therefore greater overall turndown capacity compared to prior art catalytic oxidisers.

The quantity of VOCs passed to the catalytic oxidiser 18 will be smaller in this invention than would be the case with the prior art catalytic oxidiser by virtue of the VOC destruction occurring within engine 5. It follows that those factors which cause the catalyst performance to fall, such as fouling and poisoning, will be reduced compared with the prior art. Consequently the maintenance cost of the catalytic oxidiser 18 will be reduced In this invention compared with a catalytic oxidiser of the prior art.

The temperature of stream 17 shall be at the required level suitable for catalytic combustion of the VOCs present. In the event that the temperature of stream 17 is too cool, due for example to a fall off in the concentration of VOCs in stream 2, then additional heat may be added through burner 12. After oxidation in catalytic oxidiser 18, the hot gases will leave in stream 20.

A further advantage over the prior art of engine oxidation is that the provision of burner 12 provides a safeguard against engine 5 downtime. This downtime figure is typically between 7-10% over a year and for these periods VOC destruction can be accomplished within the catalytic bed 15. Consequently the VOC abatement efficiency of system 1 is higher than that of the previous engine oxidiser art.

When the engine 5 is not working isolating valves associated with the engine, (not shown in FIG. 2) will cut off the flow of stream 36 to the engine. The control system will respond by opening valve 38 so that stream 3 will reach oxidiser 18, valve 30 will be closed as the addition of fresh in this case would serve no useful purpose. Burner 12 will be switched on to mimic the thermal output of the engine so that the temperature of stream 17 is appropriate for good combustion as previously described.

Alternatively if the volumetric requirement of the engine is small compared with stream 2, valve 31 may be closed on engine shutdown so that stream 4 is the same as stream 2. In this case burner 12 will perform the same role but would have to be positioned appropriately so that the stream 17 reaches the target temperature for oxidiser 18.

With continued reference to FIG. 2, a portion of the energy present in stream 20 is required in heat exchanger 13 to preheat stream 9. If excess energy is present in stream 20 it may be removed for use elsewhere in the industrial process, for example by division into stream 21. In this case stream 23 will contain sufficient energy to heat stream 9. The energy from stream 21 may be utilised directly, or transferred into other useful forms via heat exchanger 22.

It will be recognised that the present invention shall be especially suitable for operation with an adsorption/desorption concentration device, whereby the process gases are concentrated prior to treatment and may be considered as stream 2. Alternatively, an adsorption/desorption concentration device could be placed in stream 3. In these cases the energy associated with stream 11 or 7 could be usefully employed to drive the desorption cycle of such a concentrator. It has been noted that a fundamental characteristic of concentrators is that they produce a concentrated VOC flow which is at an elevated temperature, and batch-type concentrators produce VOC flows which have temperature variations through the cycle as the adsorption/desorption process occurs. As has previously been explained, engines are sensitive to temperatures above 20-40 C. and to rapid temperature fluctuations, and consequently with the prior art it is necessary to de-rate the engine. With the control system described herein it is possible to operate the engines at full rated electrical output and avoid de-ration.

From the foregoing, it will be appreciated that numerous variations and modifications may be implemented without departing from the true spirit and scope of the subject invention. In particular when the catalytic, oxidiser is replaced by an alternative abatement technique. It is understood that no limitation with respect to the specifically described method and apparatus is intended or should be inferred. Rather, it is intended that all such modifications should be included within the scope of the claims.

1. A system for abating a gas flow consisting of one or more streams containing volatile organic compounds (VOCs) comprising:
a) At least one combustion engine, with a primary fuel flow, for the purpose of generating power;
b) An air stream into the combustion engine;
c) A combustion unit for oxidising VOC;
d) Means of splitting the gas flow into at least two streams A and B, in any proportion or manner, so that stream A passes to the air stream of one or more of the combustion engines in any proportion, forming a combined stream C and stream B passes to the combustion unit;
e) Means for detecting the VOC concentration and/or flow rate of stream A and/or the combined stream C of the air stream and stream A and means for controlling the air stream and/or stream A and/or stream C and/or means for controlling the primary fuel to the engine(s) in response to the detected VOC concentration and/or flow rate to provide the optimal ratio/quantity of gases to the engine in accordance with the requirements of the engine;

2. A system according to claim 1 additionally comprising a means for transferring at least a portion of the exhaust heat from the engine into stream B.

3. A system according to claims 1 and 2 wherein the portion of exhaust from the engine not flowing into stream B is abated by a separate catalytic, or thermal oxidiser, or flair or dispersion device.

4. A system according to claim 1 and 2 additionally comprising a heat exchanger to transfer exhaust heat from the combustion unit to pre-heat stream B prior to entering the combustion unit.

5. A system according to claim 4 wherein the heat exchanger is a plate, shell and tube or regenerative heat exchanger.

6. A system according to any preceding claim having a burner and fan to provide additional heat to stream B.

7. A system according to claim 6 having a means for diverting stream A into stream B when the engine is offline.

8. A system according to any preceding claim additionally comprising a concentrator for increasing the VOC concentration in the gas flow of stream A and/or stream B.

9. A system according to claim 8 wherein a portion of the exhaust gas from the combustion engine and/or from the combustion unit is used to heat the desorption flow of the concentrator.

10. A system according to any preceding claim additionally comprising a device for evaporating liquid VOCs into stream A and/or the combined stream C of the air stream and stream A to increase the concentration of VOCs in response to a detected decrease in the concentration of VOCs in stream A and/or the combined stream C of the air stream and stream A below the requirements of the engine.

11. A system according to any preceding claim additionally comprising a means of detecting the temperature of stream A and/or the combined stream C of the air stream and stream A and means of controlling the air stream and/or stream A and/or stream C and/or means of controlling the primary fuel flow to the engine in response to the detected temperature to provide the optimal temperature of gases to the engine in accordance with the requirements of the engine.

12. A system according to any preceding claims wherein the VOC concentration is detected by means of one or a combination of direct measurements such as a total hydrocarbon measuring instrument, a gas chromatograph, liquid-phase VOC flowrate measurement or the like,.

13. A system according to any preceding claims wherein the VOC concentration is detected indirectly by means of one or a combination of measurements from the system, such as engine knock intensity, primary fuel flowrate to the engine, system temperatures and the like,.

14. A system according to any preceding claims wherein the flow of stream A and the air stream is adjustable by any control valve system and/or variable speed drive fan(s)

15. A system according to any preceding claims wherein the combustion engine is a reciprocating or a gas turbine type or a fuel cell.

16. A system according to any preceding claims wherein the means for transferring the exhaust heat from the engine is a heat exchanger or a direct mixer.

17. A system according to any of the preceding claims wherein the combustion unit is a catalytic or thermal oxidiser.

18. A system according to any preceding claims wherein the combustion unit is replaced by a solvent recovery system or a flair or dispersion device.

19. A method of abating a gas flow consisting of one or more streams containing volatile organic compounds comprising the steps of:
a) Splitting the gas flow into two streams A and B in any manner or proportion;
b) Mixing stream A in any proportion into the air stream of one or more devices for generating power, forming a combined stream C, where the device for generating power has a primary fuel flow;
c) Detecting the mass flow and/or concentration of VOCs in stream A and/or the combined stream C of the air stream and stream A;
d) Controlling the air stream and/or stream A and/or stream C and/or the primary fuel flow to the devices for generating power in response to the detected VOC concentration and/or mass flow rate to provide the optimal ratio/quantity of gases in accordance with the requirements of the devices for generating power;
e) Passing stream B into any VOC control device.

20. A method according to claim 19 comprising the step of heating stream B with at least a portion of the exhaust heat from the devices for generating power.

21. A method according to claims 19 and 20 comprising the step of abating the portion of the exhaust from the devices for generating power not combining with stream B in a separate VOC control device.

22. A method according to claims 19 and 20 comprising the step of transferring exhaust heat from the combustion unit to pre-heat stream B prior to entering the VOC control device.

23. A method according to claim 19 to 22 comprising the step of increasing the VOC concentration in streams A and/or B using a concentrator.

24. A method according to claim 23 comprising the step of heating the desorption flow of the concentrator with a portion of the exhaust from the devices for generating power and/or from the VOC control device.

25. A method according to any of claims 19 to 24 additionally comprising the step of evaporating liquid phase VOCs for passing into stream A and or the combined stream C of the air stream and stream A to increase the concentration of VOCs in response to a detected decrease in the concentration of VOCs in stream A and/or the combined stream C of the air stream and stream A below the requirements of the device(s) for generating power

26. A method according to any claim 19 to 25 additionally comprising the step of detecting the temperature of stream A and/or the combined stream C of the air stream and stream A and controlling the air stream and/or stream A and/or stream C and/or the primary fuel flow to the devices for generating power in response to the detected temperature to provide the optimal temperature of gases in accordance with the requirements of the devices for generating power

27. A method according to any claim 19 to 26 additionally comprising the step of detecting the temperature of stream A and/or the combined stream C of the air stream and stream A and controlling the primary fuel flow in response to changes in temperature in accordance with the requirements of the devices for generating power.

28. A method according to any claim 19 to 27 wherein the VOC concentration is detected by means of one or a combination of direct measurements, such as VOC concentration measurement and liquid-phase VOC injection flowrate.

29. A method according to any claim 19 to 27 wherein the VOC concentration is detected indirectly by means of one or a combination of measurement(s) from the system, such as engine knock intensity, primary fuel flow to the devices for generating power and temperatures throughout the system.
